(19) United States
(12) Patent Application Publication
(10) Pub. No.: US 2021/0029084 A1
(43) Pub. Date: Jan. 28, 2021

(54) OPERATION MANAGEMENT APPARATUS, METHOD, AND NON-TRANSITORY COMPUTER READABLE MEDIUM

(71) Applicant: NEC CORPORATION, Tokyo (JP)

(72) Inventor: Koichi YOSHIDA, Tokyo (JP)

(73) Assignee: NEC CORPORATION, Tokyo (JP)

(21) Appl. No.: 16/982,177

(22) PCT Filed: Sep. 5, 2018
(86) PCT No.: PCT/JP2018/032940

§ 371 Date: Sep. 18, 2020

(30) Foreign Application Priority Data
Mar. 30, 2018 (JP) 2018-067078

(51) Int. Cl. H04L 29/06; H04L 12/755; H04L 12/751; H04L 12/721

(52) U.S. Cl. CPC H04L 63/0245; H04L 63/0254; H04L 45/14; H04L 45/10; H04L 45/021

(57) ABSTRACT

An object is to provide an operation management apparatus, a method, and a program capable of predicting, when a service providing apparatus for providing services to users stops its operation for a predetermined time, effects on the services. An operation management apparatus according to the present disclosure includes an acquisition unit configured to acquire stop information indicating that a predetermined apparatus stops its operation for a predetermined time, and a specification unit configured to specify communication route information containing the predetermined apparatus from communication list information as specified communication route information, the communication list information including a plurality of pieces of communication route information in which communication transmission-source apparatus information, in-route apparatus information, transmission-destination apparatus information, and a communication allowable time are associated with each other.

### TECHNICAL FIELD

The present disclosure relates to an operation management apparatus, a method, and a program. In particular, the present disclosure relates to an operation management apparatus, a method, and a program capable of predicting, when a service providing apparatus for providing services to users stops its operation for a predetermined time, effects on the services.

### BACKGROUND ART

In recent years, systems have been increasingly complicated, so that when a service providing apparatus in such complicated systems is stopped due to a failure, or a planned repairing work or the like, it is necessary to, by spending many man-hours, check the effect on services by checking the design documents of the service providing apparatus and/or inquiring the designer of the system.

Therefore, there is a problem that it is difficult to predict beforehand which services will be affected when a service providing apparatus is stopped due to a failure, or a planned repairing work or the like.

Patent Literature 1 discloses a receiving terminal including a reception stack unit connected to a communication network, an issuance management unit that transmits a data request packet, and an H-RTT measurement unit that determines a time-out time until the data request packet is retransmitted and retransmits, according to the determined time-out time, the data request packet until the reception stack unit receives the data. Further, Patent Literature 1 mentions that the H-RTT measurement unit of the receiving terminal measures, for each communication interface, an RTT between that communication interface and a data holding node and determines the time-out time based on the measured RTT. Patent Literature 1 does not disclose anything about a prediction about effects on services when a service providing apparatus stops its operation for a predetermined time due to a failure, or a planned repairing work or the like.

### CITATION LIST

### Patent Literature

Patent Literature 1: International Patent Publication No. WO2014/083739

### SUMMARY OF INVENTION

### Technical Problem

As described above, there has been a problem that when a service providing apparatus for providing services to users stops its operation for a predetermined time, it is difficult to predict the effect on the services.

An object of the present disclosure is to provide an operation management apparatus, a method, and a program for solving at least one of the above-described problems.

### Solution to Problem

An operation management apparatus according to the present disclosure includes:

an acquisition unit configured to acquire stop information indicating that a predetermined apparatus stops its operation for a predetermined time;

a specification unit configured to specify communication route information containing the predetermined apparatus from communication list information as specified communication route information, the communication list information including a plurality of pieces of communication route information in which communication transmission-source apparatus information, in-route apparatus information, transmission-destination apparatus information, and a communication allowable time are associated with each other; and

a determination unit configured to, when the predetermined time is longer than the communication allowable time of the specified communication route information, specify communication service information containing the specified communication route information from service sequence list information as a specified communication service and determine that the specified communication service is stopped, the service sequence list information including a plurality of pieces of communication service information in which the communication route information is associated with an order according to which the communication route information is performed.

A method according to the present disclosure includes:

acquiring stop information indicating that a predetermined apparatus stops its operation for a predetermined time;

specifying communication route information containing the predetermined apparatus from communication list information as specified communication route information, the communication list information including a plurality of pieces of communication route information in which communication transmission-source apparatus information, in-route apparatus information, transmission-destination apparatus information, and a communication allowable time are associated with each other; and

specifying, when the predetermined time is longer than the communication allowable time of the specified communication route information, communication service information containing the specified communication route information from service sequence list information as a specified communication service and determining that the specified communication service is stopped, the service sequence list information including a plurality of pieces of communication service information in which the communication route information is associated with an order according to which the communication route information is performed.

A program according to the present disclosure causes a computer to:

acquire stop information indicating that a predetermined apparatus stops its operation for a predetermined time;

specify communication route information containing the predetermined apparatus from communication list information as specified communication route information, the communication list information including a plurality of pieces of communication route information in which communication transmission-source apparatus information, in-route apparatus information, transmission-destination apparatus information, and a communication allowable time are associated with each other; and

specify, when the predetermined time is longer than the communication allowable time of the specified communication route information, communication service information containing the specified communication route information from service sequence list information as a specified communication service and determine that the specified communication service is stopped, the service sequence list information including a plurality of pieces of communication service information in which the communication route information is associated with an order according to which the communication route information is performed.

### Advantageous Effects of Invention

According to the present disclosure, it is possible to provide an operation management apparatus, a method, and a program capable of predicting, when a service providing apparatus for providing services to users stops its operation for a predetermined time, effects on the services.

### BRIEF DESCRIPTION OF DRAWINGS

FIG. 1 is a block diagram showing an example of an operation management apparatus according to a first example embodiment;

FIG. 2 is a block diagram showing an example of a system according to the first example embodiment;

FIG. 3 is a flowchart showing an example of operations performed by the system according to the first example embodiment;

FIG. 4 is a schematic diagram showing an example of operations performed by the operation management apparatus according to the first example embodiment;

FIG. 5 is a schematic diagram showing an example of operations performed by the operation management apparatus according to the first example embodiment;

FIG. 6 is a schematic diagram showing an example of operations performed by the operation management apparatus according to the first example embodiment;

FIG. 7 is a flowchart showing an example of operations performed by a system according to a second example embodiment; and

FIG. 8 is a schematic diagram showing an example of operations performed by an operation management apparatus according to the second example embodiment.

### DESCRIPTION OF EMBODIMENTS

Example embodiments according to the present invention will be described hereinafter with reference to the drawings. The same or corresponding elements are denoted by the same symbols throughout the drawings, and redundant explanations are omitted as appropriate for the sake of clarity.

### First Example Embodiment

Firstly, an overview will be described.

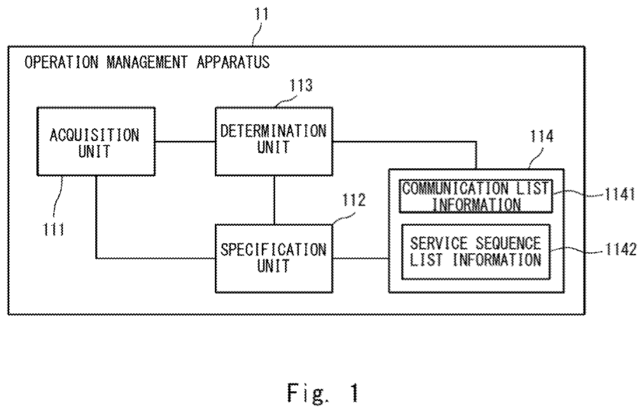

FIG. 1 is a block diagram showing an example of an operation management apparatus according to a first example embodiment.

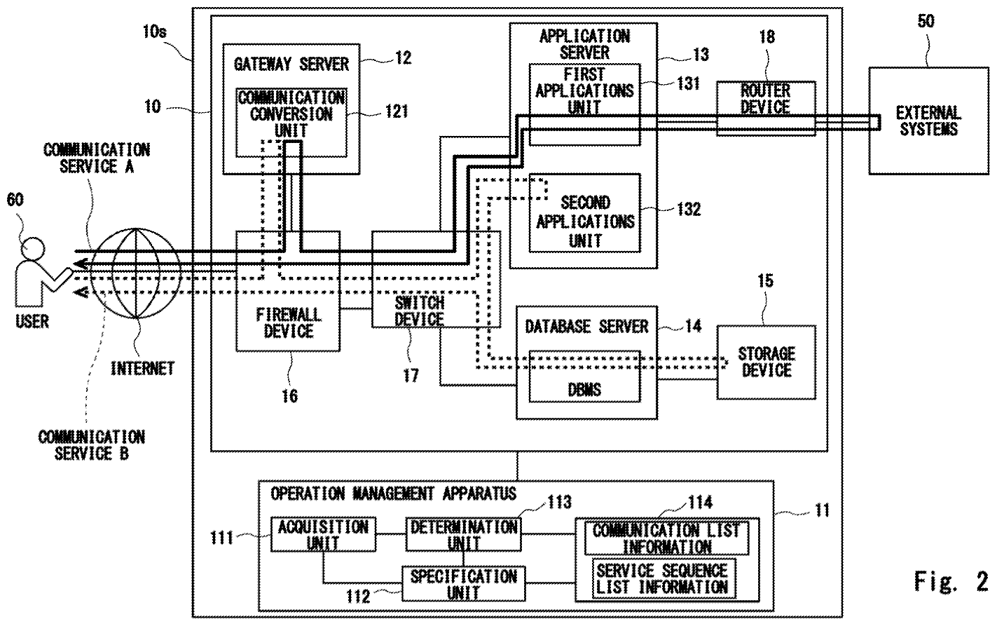

FIG. 2 is a block diagram showing an example of a system according to the first example embodiment.

As shown in FIGS. 1 and 2, a system 10s includes a service providing apparatus 10 and an operation management apparatus 11 that operates and manages the service providing apparatus 10. The service providing apparatus 10 provides various services to a user 60. The service providing apparatus 10 includes, for example, a gateway server 12, an application server 13, a database server 14, a firewall device 16, a switch device 17, a router device 18, and a storage device 15. The severs and devices of the service providing apparatuses 10 are connected to one another as shown in FIG. 2, and they provide services to the user 60 through the Internet.

The gateway server 12 includes a communication conversion unit 121. The communication conversion unit 121 converts a communication protocol into a different communication protocol and vice versa, and thereby establishes a connection between different communication protocols.

The application server 13 includes a first application unit 131 and a second application unit 132. The first application unit 131 has a communication service A function for providing a communication service A. The second application unit 132 has a communication service B function for providing a communication service B. The communication services A and B may also be referred to as services A and B, respectively.

The database server 14 has a DBMS (DataBase Management System). The database server 14 manages a database and operates the database in response to a request from the outside.

The router device 18 is disposed between the application server 13 and the external system 50, and relays data therebetween.

The storage device 15 stores various types of data.

The firewall device 16 protects the service providing apparatus 10 from unauthorized access through the Internet.

The switch device 17 changes the destination of data related to a communication service according to the purpose of that communication service.

The user 60 requests, for example, a communication service A through the Internet, and the service providing apparatus 10 provides the communication service A to the user 60. Specifically, when the user 60 requests the communication service A, the request is sent from the user 60 to the application server 13 through the Internet, the firewall device 16, the gateway server 12, and the switch device 17. The request is further sent from the first application unit 131 of the application server 13 to an external system 50 through the router device 18. Upon receiving the request, the external system 50 transmits a response to the request. The response is sent from the external system 50 to the switch device 17 through the router device 18 and the first application unit 131 of the application server 13. The response is further sent from the switch device 17 to the user 60 through the firewall device 16 and the Internet, and hence the communication service A is provided to the user 60.

Further, the user 60 requests, for example, the communication service B through the Internet, and the service providing apparatus 10 provides the communication service B to the user 60. Specifically, when the user 60 requests the communication service B, the request is sent from the user 60 to the application server 13 through the Internet, the firewall device 16, the gateway server 12, and the switch device 17. The request is further sent from the second application unit 132 of the application server 13 to the storage device 15 through the switch device 17 and the database server 14. Upon receiving the request, the storage device 15 transmits a response to the request. The response is sent from the storage device 15 to the user 60 through the database server 14, the switch device 17, the firewall device 16, and the Internet, and hence the communication service B is provided to the user 60.

The operation management apparatus 11 operates and manages the service providing apparatus 10. The operation management apparatus 11 includes an acquisition unit 111, a specification unit 112, a determination unit 113, and a storage unit 114.

The acquisition unit 111 acquires stop information indicating that, among service providing apparatuses 10, a predetermined apparatus will stop its operation for a predetermined time. The stop information includes predetermined apparatus information for specifying an apparatus that will be stopped and a stop time during which the apparatus will be stopped.

The predetermined apparatus includes at least one of the servers, the storage device 15, the firewall device 16, the switch device 17, and the router device 18. The gateway server, the application server, and the database server may be collectively called the server(s).

The specification unit 112 specifies communication route information containing the predetermined apparatus from the communication list information as specified communication route information. The communication list information is information including a plurality of pieces of communication route information in which communication transmission-source apparatus information, in-route apparatus information, transmission-destination apparatus information, and a communication allowable time are associated with each other. The communication allowable time is an allowable time. When the stop time is equal to or shorter than this allowable time, communication is not determined to be interrupted and is determined to be still continued. Details of the communication list information will be described later.

When the predetermined time is longer than the communication allowable time of the specified communication route information, the determination unit 113 specifies communication service information containing the specified communication route information from the service sequence list information as a specified communication service, and determines that the specified communication service will be stopped. The service sequence list information is information including a plurality of pieces of communication service information in which communication route information is associated with the order according to which the communication route information is performed. Details of the service sequence list information will be described later.

Note that the operation management apparatus 11 may further include a comparison unit (not shown) that compares the predetermined time with the communication allowable time of the specified communication route information. Further, the communication allowable time may also be referred to as a time-out value.

Next, details will be described.

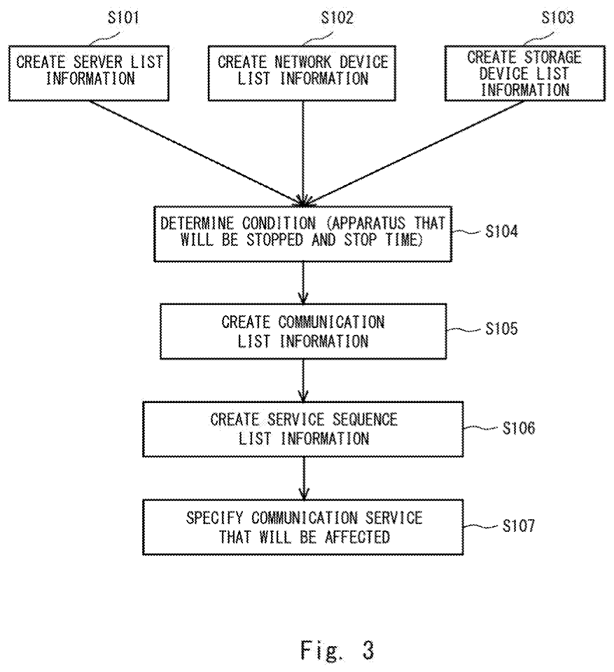

FIG. 3 is a flowchart showing an example of operations performed by the system according to the first example embodiment.

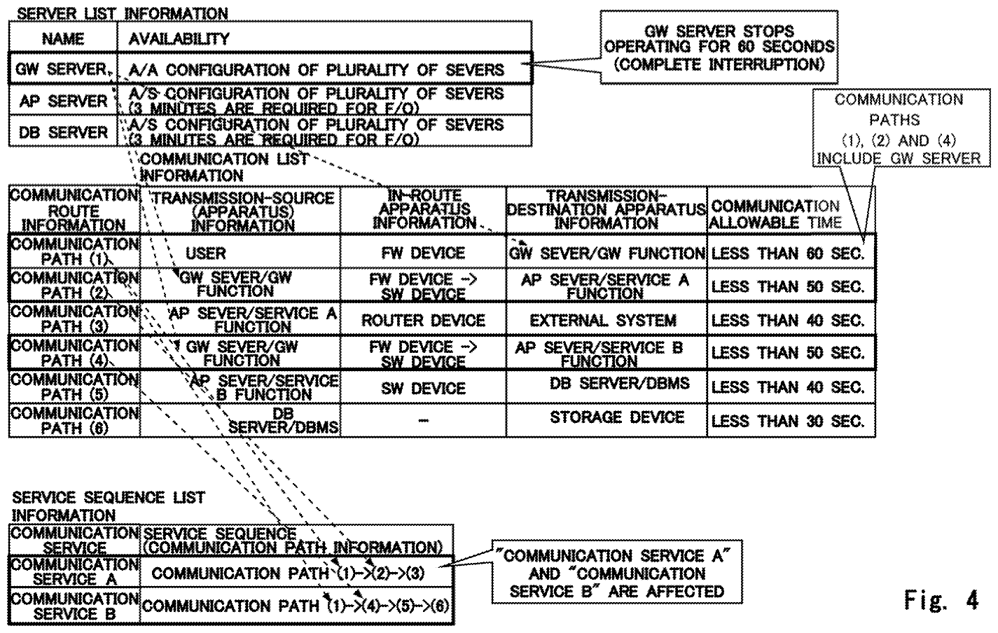

FIG. 4 is a schematic diagram showing an example of operations performed by the operation management apparatus according to the first example embodiment.

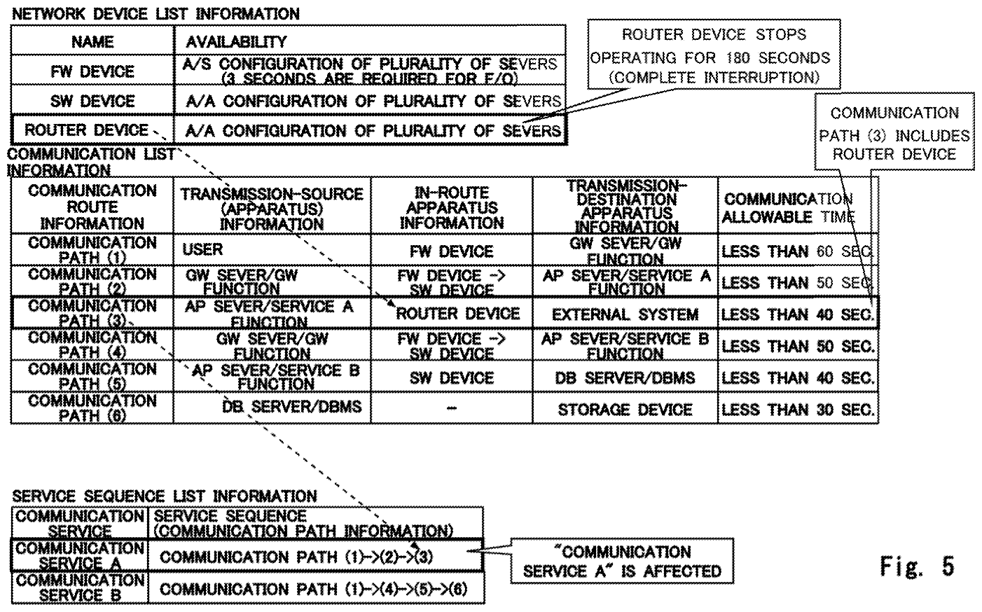

FIG. 5 is a schematic diagram showing an example of operations performed by the operation management apparatus according to the first example embodiment.

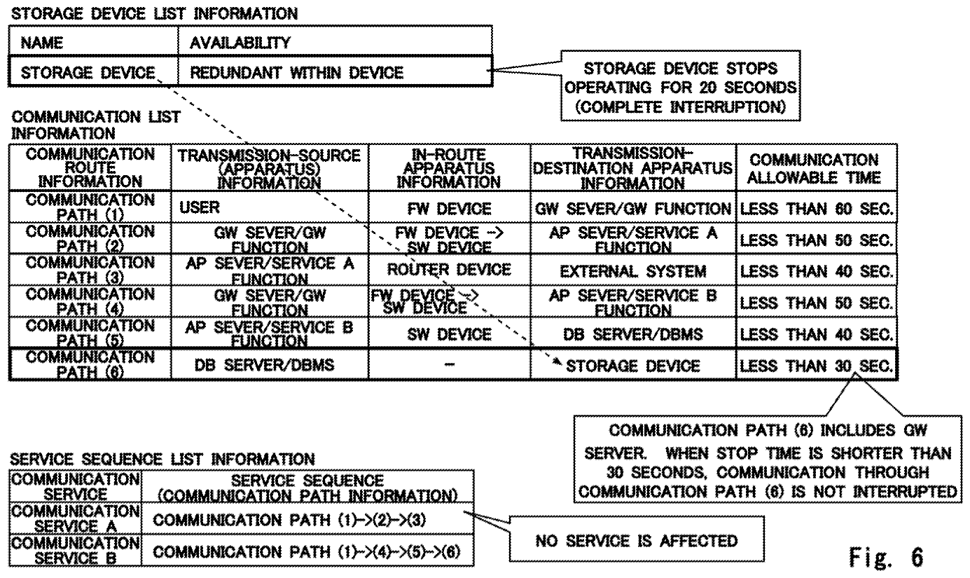

FIG. 6 is a schematic diagram showing an example of operations performed by the operation management apparatus according to the first example embodiment.

A GW server shown in FIGS. 4 to 6 represents a gateway server, and an AP server represents an application server. Further, a DB server represents a database server. An FW device shown in FIGS. 4 to 6 represents a firewall device, and an SW device represents a switch device. Further a GW function represents a gateway function. A/A shown in FIGS. 4 to 6 represents an active/active operation configuration, and A/S represents an active/standby operation configuration. F/O shown in FIGS. 4 to 6 represents fail-over.

Communication list information shown in FIG. 4 shows information related to communication paths. For example, a communication path (1) indicates a communication path from a user to a gateway server through a firewall device, and indicates that a time allowed for the communication path (1) is less than 60 seconds.

Service sequence list information shown in FIG. 4 shows information related to communication services. For example, a communication service A is provided from the communication path (1) and reaches an external system through communication paths (2) and (3).

As shown in FIG. 3, the operation management apparatus 11 creates the server list information shown in FIG. 4 (step S101). The server list information is information in which types of servers are associated with availabilities of the servers. The servers include, for example, a gateway server, an application server, and a database server.

The operation management apparatus 11 creates the network device list information shown in FIG. 5 (step S102). The network device list information is information in which types of network devices are associated with availabilities of the network devices. The network devices include, for example, a firewall device, a switch device, and a router device.

The operation management apparatus 11 creates the storage device list information shown in FIG. 6 (step S103). The storage list information is information in which storage devices are associated with availabilities of the storage devices.

The operation management apparatus 11 determines conditions as to which of service providing apparatuses 10 stops its operation and how long it stopes the operation (step S104). That is, the operation management apparatus 11 determines an apparatus that will be stopped and its stop time. The operation management apparatus 11 acquires stop information indicating that, among service providing apparatuses 10, a predetermined apparatus stops its operation for a predetermined time. The operation management apparatus 11 may determine the apparatus that will be stopped and its stop time based on the stop information.

The operation management apparatus 11 creates the communication list information shown in FIGS. 4 to 6 (step S105).

The operation management apparatus 11 creates the service sequence list information shown in FIGS. 4 to 6 (step S106).

The operation management apparatus 11 searches for and specifies a communication service(s) related to the apparatus that will be stopped from the communication list information and the service sequence list information. As a result of the search, the operation management apparatus 11 specifies a communication service(s) that will be affected (step S107). Specifically, the operation management apparatus 11 specifies communication route information containing the apparatus that will be stopped from the communication list information. When the stop time is longer than the communication allowable time of the specified communication route information, the operation management apparatus 11 further specifies communication service information containing the specified communication route information from the service sequence list information.

Next, operations performed by the operation management apparatus 11 will be described by using an example in which the gateway server 12 stops its operation for 60 seconds.

As shown in FIG. 4, the operation management apparatus 11 specifies communication route information containing the gateway server 12, which is the apparatus that will be stopped, from the communication list information as specified communication path information. In this example, the operation management apparatus 11 specifies communication paths (1), (2) and (4) as the specified communication path information.

The stop time of the gateway server 12 is 60 seconds. The communication allowable time of the communication path (1) is less than 60 seconds. The communication allowable time of the communication path (2) is less than 50 seconds. The communication allowable time of the communication path (4) is less than 50 seconds.

The operation management apparatus 11 determines that the stop time of the gateway server 12 is longer than the communication allowable time of the communication path (1). The operation management apparatus 11 determines that the stop time of the gateway server 12 is longer than the communication allowable time of the communication path (2). The operation management apparatus 11 determines that the stop time of the gateway server 12 is longer than the communication allowable time of the communication path (4). Then, in this case, the operation management apparatus 11 specifies communication service information containing the communication paths (1), (2) and (4) from the service sequence list information. The communication service information containing the communication paths (1), (2) and (4) is those for communication services A and B. The operation management apparatus 11 predicts (determines) that the communication services A and B will be stopped.

Next, operations performed by the operation management apparatus 11 will be described by using an example in which the router device 18 stops its operation for 180 seconds.

As shown in FIG. 5, the operation management apparatus 11 specifies communication route information containing the router device 18, which is the apparatus that will be stopped, from the communication list information as specified communication path information. In this example, the operation management apparatus 11 specifies a communication path (3) as the specified communication path information.

The stop time of the router device 18 is 180 seconds. The communication allowable time of the communication path (3) is less than 40 seconds.

The operation management apparatus 11 determines that the stop time of the router device 18 is longer than the communication allowable time of the communication path (3). Then, in this case, the operation management apparatus 11 specifies communication service information containing the communication path (3) from the service sequence list information. The communication service information containing the communication path (3) is that for the communication service A. The operation management apparatus 11 predicts that the communication service A will be stopped.

Next, operations performed by the operation management apparatus 11 will be described by using an example in which the storage device 15 stops its operation for 20 seconds.

As shown in FIG. 6, the operation management apparatus 11 specifies communication route information containing the storage device 15, which is the apparatus that will be stopped, from the communication list information as specified communication path information. In this example, the operation management apparatus 11 specifies a communication path (6) as the specified communication path information.

The stop time of the storage device 15 is 20 seconds. The communication allowable time of the communication path (6) is less than 30 seconds.

The operation management apparatus 11 does not determine that the stop time of the storage device 15 is longer than the communication allowable time of the communication path (6), and instead determines that it is shorter than the communication allowable time of the communication path (6). When the stop time is shorter than 30 seconds, communication through the communication path (6) is not interrupted. In this case, the operation management apparatus 11 predicts that no communication service is affected.

The operation management apparatus 11 according to the first example embodiment searches for and specifies a communication service(s) related to an apparatus that will be stopped from communication list information and service sequence list information. That is, the operation management apparatus 11 has a function of managing a service sequence and the system 10s including various types of apparatuses in a consolidated manner. In this way, the operation management apparatus 11 can specify which of the apparatuses included in the system 10s will affect, when the operation of that apparatus is stopped, which of the communication services, and also specify the minimum duration which when that apparatus is stopped for, it will affect that communication service.

As a result, it is possible to provide an operation management apparatus, a method, and a program capable of predicting, when a service providing apparatus for providing services to users stops its operation for a predetermined time, effects on the services.

### Second Example Embodiment

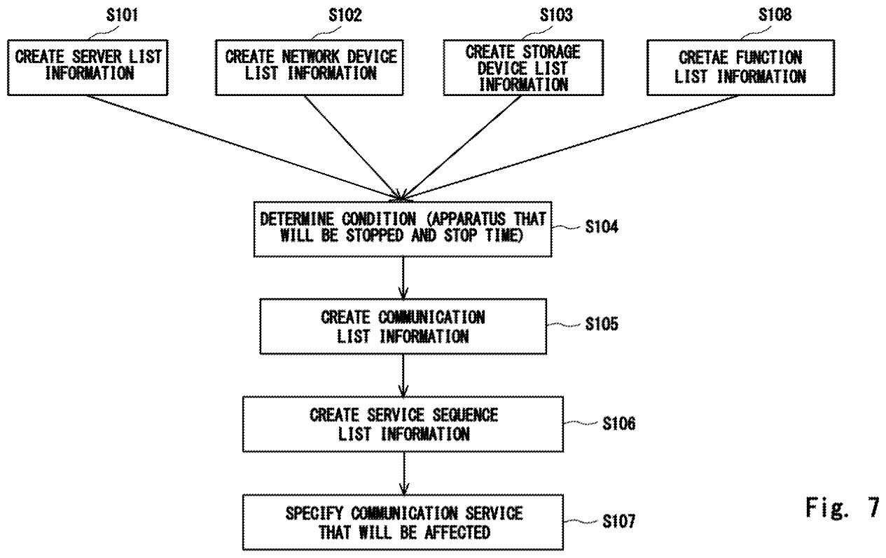

FIG. 7 is a flowchart showing an example of operations performed by a system according to a second example embodiment.

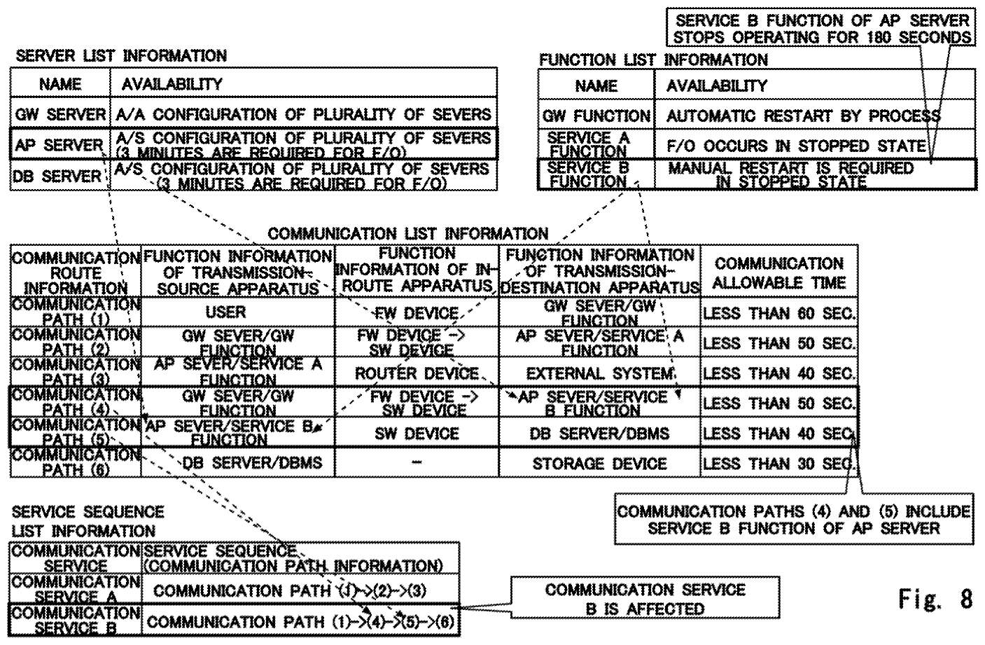

FIG. 8 is a schematic diagram showing an example of operations performed by an operation management apparatus according to the second example embodiment.

As shown in FIG. 7, the operation management apparatus according to the second example embodiment is different from the operation management apparatus 11 according to the first example embodiment because the operation management apparatus according to the second example embodiment has function list information. Prior to proceeding to the step S104, the operation management apparatus according to the second example embodiment creates the function list information shown in FIG. 8 (step S108).

The function list information is information in which types of functions of servers are associated with availabilities of the functions.

The acquisition unit of the operation management apparatus according to the second example embodiment acquires stop information indicating that an operation by a predetermined function of a predetermined apparatus among service providing apparatuses 10 will be stopped for a predetermined time. The stop information according to the second example embodiment is information containing predetermined apparatus information for specifying an apparatus that will be stopped, predetermined function information for specifying a function of the apparatus that will be stopped, and a stop time during which the apparatus will be stopped.

A specification unit of the operation management apparatus according to the second example embodiment specifies communication route information containing a predetermined function of a predetermined apparatus from communication list information as specified communication route information. The communication list information according to the second example embodiment is information including a plurality of pieces of communication route information in which function information of a communication transmission-source apparatus, function information of an in-route apparatus, function information of a transmission-destination, and a communication allowable time are associated with each other.

According to the second example embodiment, when the predetermined time is longer than the communication allowable time of the specified communication route information, a determination unit of the operation management apparatus specifies communication service information containing the specified communication route information from service sequence list information as specified communication service. Then, the determination unit of the operation management apparatus according to the second example embodiment determines that the specified communication service will be stopped.

Operations performed by the operation management apparatus according to the second example embodiment will be described by using an example in which the operation by a communication service B function of an application server according to the second example embodiment is stopped for 180 seconds.

As shown in FIG. 8, the operation management apparatus according to the second example embodiment specifies communication route information containing the communication service B function of the application server, which are the function and the apparatus that will be stopped, from the communication list information as specified communication path information. In this example, the operation management apparatus according to the second example embodiment specifies communication paths (4) and (5) as the specified communication path information.

The stop time of the communication service B function of the application server according to the second example embodiment is 180 seconds. The communication allowable time of the communication path (4) is less than 50 seconds. The communication allowable time of the communication path (5) is less than 40 seconds.

The operation management apparatus according to the second example embodiment determines that the stop time of the communication service B function of the application server according to the second example embodiment is longer than the communication allowable time of the communication path (4). The operation management apparatus according to the second example embodiment determines that the stop time of the communication service B function of the application server according to the second example embodiment is longer than the communication allowable time of the communication path (5). Then, in this case, the operation management apparatus according to the second example embodiment specifies the communication service information containing the communication path (4) or (5) from the service sequence list information. The communication service information containing the communication path (4) or (5) is that for the communication service B. The operation management apparatus according to the second example embodiment predicts that the communication service B will be stopped.

The operation management apparatus according to the second example embodiment can predict, even when the operation by a predetermined function of a predetermined apparatus is stopped for a predetermined time, the effect on the service.

Note that although the present invention is described as a hardware configuration in the above-described example embodiments, the present invention is not limited to the hardware configurations. In the present invention, the processes in each of the components can also be implemented by having a CPU (Central Processing Unit) execute a computer program.

In the above-described example embodiments, the program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

Note that the invention is not limited to the above-described example embodiments and various changes may be made therein without departing from the spirit and scope of the present invention.

Although the present invention is explained above with reference to example embodiments, the present invention is not limited to the above-described example embodiments. Various modifications that can be understood by those skilled in the art can be made to the configuration and details of the present invention within the scope of the invention.

This application is based upon and claims the benefit of priority from Japanese patent applications No. 2018-067078, filed on Mar. 30, 2018, the disclosure of which is incorporated herein in its entirety by reference.

### REFERENCE SIGNS LIST

10 SERVICE PROVIDING APPARATUS
10s SYSTEM
11 OPERATION MANAGEMENT APPARATUS
111 ACQUISITION UNIT
112 SPECIFICATION UNIT
113 DETERMINATION UNIT
114 STORAGE UNIT
12 GATEWAY SERVER
121 COMMUNICATION CONVERSION UNIT
13 APPLICATION SERVER
131 FIRST APPLICATIONS UNIT
132 SECOND APPLICATIONS UNIT
14 DATABASE SERVER
141 DATABASE MANAGEMENT UNIT
15 STORAGE DEVICE
16 FIREWALL DEVICE
17 SWITCH DEVICE
18 ROUTER DEVICE
50 EXTERNAL SYSTEMS
60 USER

1. An operation management apparatus comprising:
at least one memory storing instructions, and
at least one processor configured to execute the instructions to;
acquire stop information indicating that a predetermined apparatus stops its operation for a predetermined time;
specify communication route information containing the predetermined apparatus from communication list information as specified communication route information, the communication list information including a plurality of pieces of communication route information in which communication transmission-source apparatus information, in-route apparatus information, transmission-destination apparatus information, and a communication allowable time are associated with each other; and
when the predetermined time is longer than the communication allowable time of the specified communication route information, specify communication service information containing the specified communication route information from service sequence list information as a specified communication service and determine that the specified communication service is stopped, the service sequence list information including a plurality of pieces of communication service information in which the communication route information is associated with an order according to which the communication route information is performed.

2. The operation management apparatus according to claim 1, wherein the stop information contains predetermined apparatus information for specifying the apparatus that will be stopped and a stop time during which the apparatus will be stopped.

3. The operation management apparatus according to claim 1, wherein the at least one processor is further configured to compare the predetermined time with the communication allowable time of the specified communication route information.

4. The operation management apparatus according to claim 1, wherein the communication allowable time is an allowable time, and when the stop time is equal to or shorter than the allowable time, communication is not determined to be interrupted, and instead is determined to be still continued.

5. The operation management apparatus according to claim 1, wherein the predetermined apparatus includes at least one of a server, a storage device, a firewall device, a switch device, and a router device

6. An operation management apparatus comprising:
at least one memory storing instructions, and
at least one processor configured to execute the instructions to;
acquire stop information indicating that an operation by a predetermined function of a predetermined apparatus is stopped for a predetermined time;
specify communication route information containing the predetermined function of the predetermined apparatus from communication list information as specified communication route information, the communication list information including a plurality of pieces of communication route information in which function information of a communication transmission-source apparatus, function information of an in-route apparatus, function information of a transmission-destination apparatus, and a communication allowable time are associated with each other; and
when the predetermined time is longer than the communication allowable time of the specified communication route information, specify communication service information containing the specified communication route information from service sequence list information as a specified communication service and determine that the specified communication service is stopped, the service sequence list information including a plurality of pieces of communication service information in which the communication route information is associated with an order according to which the communication route information is performed.

7. The operation management apparatus according to claim 6, wherein the stop information contains predetermined apparatus information for specifying the apparatus that will be stopped, predetermined function information for specifying the function of the apparatus that will be stopped, and a stop time during which the apparatus will be stopped.

8. The operation management apparatus according to claim 6, wherein the at least one processor is further configured to compare the predetermined time with the communication allowable time of the specified communication route information.

9. A method comprising:
acquiring stop information indicating that a predetermined apparatus stops its operation for a predetermined time;
specifying communication route information containing the predetermined apparatus from communication list information as specified communication route information, the communication list information including a plurality of pieces of communication route information in which communication transmission-source apparatus information, in-route apparatus information, transmission-destination apparatus information, and a communication allowable time are associated with each other; and
specifying, when the predetermined time is longer than the communication allowable time of the specified communication route information, communication service information containing the specified communication route information from service sequence list information as a specified communication service and determining that the specified communication service is stopped, the service sequence list information including a plurality of pieces of communication service information in which the communication route information is associated with an order according to which the communication route information is performed.

10. (canceled)
